(19) United States
(12) Patent Application Publication
(10) Pub. No.: US 2019/0094785 A1
(43) Pub. Date: Mar. 28, 2019

(54) ELECTRIFIED CONDUCTIVE CLEANER BLADE FOR PRINTERS AND MULTIFUNCTION PERIPHERALS

(71) Applicants: Kabushiki Kaisha Toshiba, Minato-ku (JP); Toshiba TEC Kabushiki Kaisha, Shinagawa-ku (JP)

(72) Inventors: Donald W. STAFFORD, Lexington, KY (US); Gary L. NOE, Lexington, KY (US); Michael W. LAWRENCE, Lexington, KY (US); Donn D. BRYANT, Lexington, KY (US)

(21) Appl. No.: 15/714,632

(22) Filed: Sep. 25, 2017

(51) Int. Cl. G03G 21/00

(52) U.S. Cl. CPC G03G 21/0023

(57) ABSTRACT

A system and method for removing residual toner and submicron particles from a photoconductive drum of a toner-based printer includes an electrified cleaner blade that electrostatically attracts residual toner and submicron particles from the photoconductive drum as the photoconductive drum is rotated towards the electrified cleaner blade. An electrostatic charge unit can be configured to apply a suitable electric charge of between −500 VDC and −2000 VDC to the electrified cleaner blade. Particles lodged on the electrified cleaner blade can be electrostatically dislodged by temporarily reversing the voltage applied to the electrified cleaner blade. Cycling the voltage applied to the electrified cleaner blade between a positive voltage and a negative voltage is used to improve the action of electrostatically dislodging particles lodged on the electrified cleaner blade. The electrified cleaner blade can apply an initial charge to the photoconductive drum.

### TECHNICAL FIELD

This application relates generally to cleaner blades on toner-based electro-photographic printers and multifunction peripherals. The application relates more particularly to an electrified cleaner blade for removing residual toner from a photoconductive drum of an electrostatic process unit of a printer.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFP means any of the forgoing.

An electrostatic process unit, or EPU, in many printers and multifunction peripherals assists in performing the printing functions. The EPU typically comprises a photoconductive drum, and a developer roller. The EPU can be configured as a field replaceable unit or can be part of a self-contained compact cartridge that includes the toner. Using magnetic and electrostatic forces, the developer roller and the photoconductive drum transfer toner from a toner hopper to a sheet of paper where it is fused by heat to the paper.

After the photoconductive drum transfers toner to the paper, a cleaner blade in the EPU removes residual toner and paper dust from the photoconductive drum. However, if residual toner and paper dust is not entirely removed from the photoconductive drum by the cleaner blade the residual toner and paper dust can degrade future print jobs, cause surface wear on the photoconductive drum, contaminate other EPU components such as the primary charge roller or the corona components and interfere with the proper operation of an electrostatic process unit.

### BRIEF DESCRIPTION OF THE DRAWINGS

FIG. 1 is a block diagram of a multifunction peripheral;

FIG. 2 is a block diagram of toner-based printing elements of an example laser printer;

FIG. 3 is a functional diagram of an example embodiment of an electrified cleaner blade for toner-based print hardware; and

FIG. 4 is a flowchart of example operations for removing residual toner and submicron particles from a photoconductive drum of a toner-based printer using an electrified cleaner blade.

### SUMMARY

In an example embodiment, an apparatus includes a cleaner blade and an electrostatic charge unit. The cleaner blade is configured to remove residual material from an associated photoconductive drum of a toner-based printer, for example by physically removing material as the drum is rotated towards the cleaner blade and by electrostatically attracting submicron particles from the drum to the cleaner blade. In a configuration, the cleaner blade includes an insulating portion and a conductive or charge carrying portion, where the conductive portion contacts the photoconductive drum. Some or all of the cleaner blade can be made of urethane treated with an ionic salt, urethane to which lithium perchlorate has been added, or treated urethane having an electrical conductivity of between approximately 10 ohm-cm to approximately −5 ohm-cm. The electrostatic charge unit can apply a second electric charge, for example a charge having the reverse polarity than the charge initially applied to the cleaner blade, to remove residual material from the cleaner blade. The cleaner blade can be configured to apply an electric charge to the photoconductive drum.

In an example embodiment, an electrostatic process unit includes a photoconductive drum that selectively attracts toner from a developer roller and deposits the attracted toner onto paper, and an electrified cleaner blade that electrostatically removes residual toner left on the photoconductive drum that was not deposited onto the paper. Some or all of the cleaner blade can be made of urethane treated with an ionic salt, urethane to which lithium perchlorate has been added, or treated urethane having an electrical conductivity of between approximately 10 ohm-cm to approximately −5 ohm-cm. The electrostatic process unit can include a primary charge roller that places a substantially uniform electric charge on the photoconductive drum. The electrified cleaner blade can work in concert with the primary charge roller to apply, for example by placing an initial electric charge on the photoconductive drum. The electrified cleaner blade can include an insulating portion and a conductive portion, where the charge is applied to the conductive portion. The electrostatic process unit can include an electrostatic charge unit for applying the charge to the electrified cleaner blade. The electrostatic charge unit can apply a second electric charge of opposite polarity to remove residual material from the cleaner blade.

In an example embodiment, a method includes placing an electric charge on at least a portion of a cleaner blade and removing, by the cleaner blade and the associated electric charge, residual material from a photoconductive drum of a toner-based print unit. The method can include placing a second electric charge on the cleaner blade to remove material from the cleaner blade. The method can include transferring charge from the cleaner blade to the photoconductive drum to place an electric charge on the photoconductive drum.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In toner-based electro-photographic printers, toner is picked up by a magnetic developer roller from a toner hopper. A precise leveling blade called a doctor blade is positioned close to the magnetic developer roller and removes excess toner to ensure there is only a thin even layer of toner on the magnetic developer roller. The magnetic developer roller rotates towards a photoconductive drum onto which an electric charge has been applied, and toner from the magnetic developer roller is electrostatically attracted to and transferred to the photoconductive drum in accordance with a desired image to be printed. The toner is then transferred from the photoconductive drum to paper and fused with the paper to form a printed page. Residual toner that is left on the photoconductive drum is removed by a cleaner blade or wiper blade into a waste bin. In addition to residual toner, the photoconductive drum can pick up paper dust from the paper. The paper dust can include submicron sized calcium carbonate commonly used in a wide range of papers.

Residual toner and paper dust, if not removed by the cleaner blade, can inadvertently end up on the printed page or settle as dust on printer parts. Dust can potentially interfere with the proper operation of an electrostatic process unit, or EPU, that typically comprises the photoconductive drum, the cleaner blade, the magnetic developer roller, and developer in a field replaceable unit or in a self-contained compact cartridge. Therefore removing residual toner and paper dust can improve the quality of printed images, reduce waste, and lower maintenance costs.

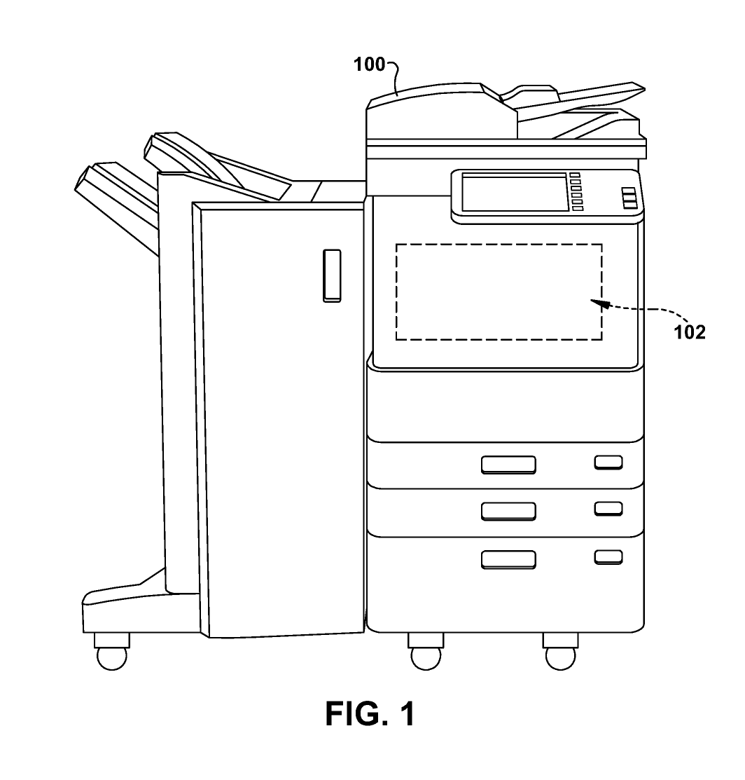

With reference to FIG. 1, an example multifunction peripheral (MFP 100) is presented. The MFP 100 includes electrostatic-based, or toner-based, printing hardware 102 for performing printing operations as would be understood in the art.

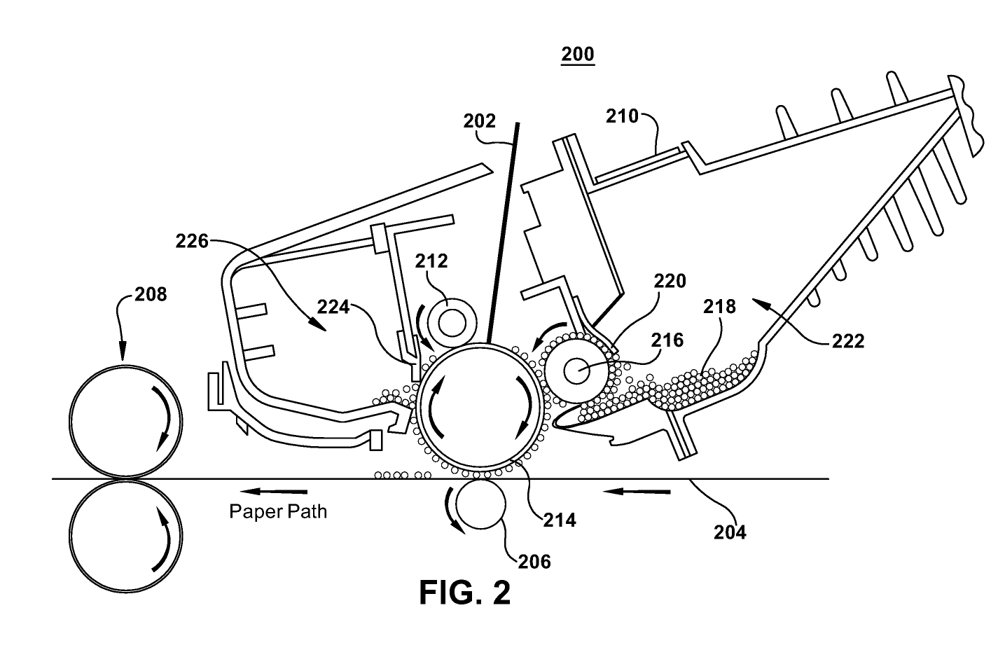

With reference to FIG. 2, a block diagram of toner-based printing hardware 200 of an example laser printer is presented. The hardware 200 includes a laser 202, or other illumination source, that selectively illuminates portions of a photoconductive drum 214 to generate the image to be printed on the paper 204. The hardware 200 can include a field replaceable cartridge 210 that facilitates replacement by the end user. In the cartridge 210, the photoconductive drum 214 receives an initial charge from a primary charge roller or PCR 212. Illumination from the laser 202 selectively changes the charge on the photoconductive drum 214 that determines whether or not portions of the photoconductive drum 214 will attract or repel toner 218. Toner 218 in the toner hopper 222 is attracted to the magnetic developer roller 216. As the magnetic developer roller 216 rotates, a doctor blade 220 removes excess toner 218 from the magnetic developer roller 216 and ensures that toner 218 is evenly distributed to a desired depth on the magnetic developer roller 216. As the magnetic developer roller 216 continues to rotate, toner 218 on the magnetic developer roller 216 is electrostatically attracted to charged portions of the photoconductive drum 214. As the photoconductive drum 214 rotates, toner 218 on the photoconductive drum 214 is electrostatically pulled from the photoconductive drum 214 onto the paper 204 by a charge associated with the transfer roller. The toner 218 on the paper 204 is then heat fused by the fusing assembly 208 to permanently bond the toner 218 to the paper 204. Residual toner 218 and paper dust is scraped from the photoconductive drum 214 by a wiper or cleaner blade 224 and deposited into a waste bin 226.

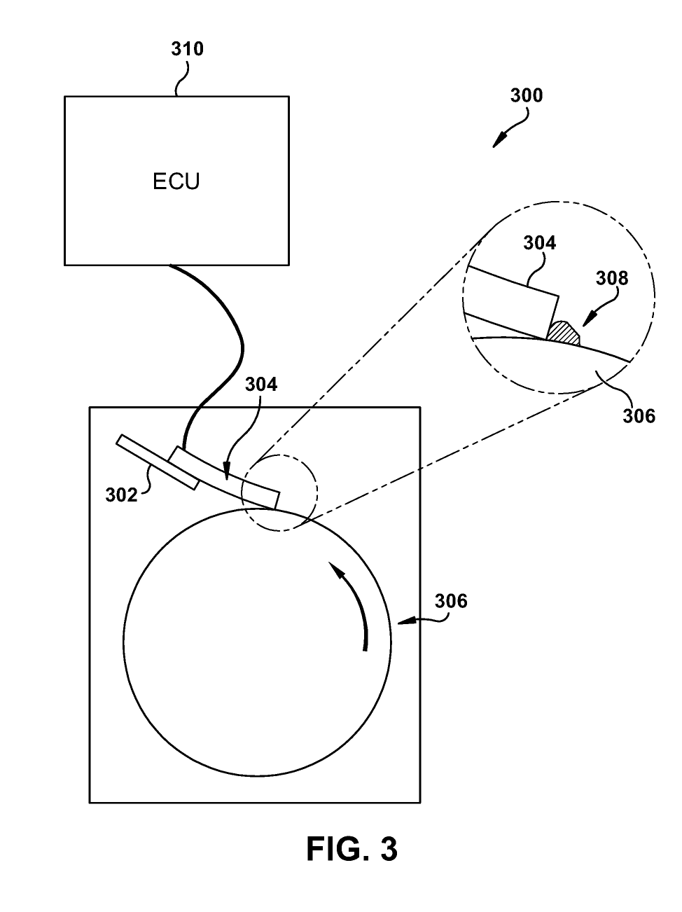

With reference to FIG. 3, a functional diagram of an embodiment of an electrified cleaner blade 300 for toner-based printing is presented. The electrified cleaner blade 300 can comprise two or more parts such as an insulated portion 302, and a conductive portion 304 such as the nip as illustrated. An example conductive portion 304 can be treated urethane or any other suitable electrically conductive material known in the art. In an embodiment, the conductive portion 304 is treated urethane made partially conductive to approximately 10 ohm-cm to approximately −5 ohm-cm by adding an ionic salt to the urethane such as lithium perchlorate, which improves conductivity without substantially affecting the material properties of the urethane. In an embodiment, the electrified cleaner blade 300 can comprise a single part that has a portion treated to be conductive. In other embodiments, the electrified cleaner blade 300 can comprise any suitable number of parts, as would be understood in the art.

The electrified cleaner blade 300 is configured to contact with, or be in close proximity to, a photoconductive drum 306. As the photoconductive drum 306 rotates toward the electrified cleaner blade 300, the electrified cleaner blade 300 removes material from the photoconductive drum 306 such as particles 308 of residual toner and dust or other materials picked up from the paper, for example calcium carbonate. In an embodiment, the electrified cleaner blade 300 can be suitably displaced by a small gap from the photoconductive drum 306 so as to not contact the photoconductive drum 306 while remaining close enough to remove substantially all of the particles 308 of toner and paper dust from the photoconductive drum 306. However, typically a cleaner blade is constructed of a flexible non-abrasive material that contacts the photoconductive drum 306 without damaging or causing substantial wear to the photoconductive drum 306.

An electrostatic charge unit, or ECU 310, can apply a suitable charge to the conductive portion 304 of the electrified cleaner blade 300. In a configuration, the ECU 310 can apply a negative voltage of between −100 VDC to −2000 VDC to the conductive portion 304 of the electrified cleaner blade 300. Advantageously, applying a charge to the electrified cleaner blade increases the effectiveness of the electrified cleaner blade 300 by removing submicron particles 308 308 from the photoconductive drum 306 that might otherwise escape under the nip of a typical cleaning blade and remain on the photoconductive drum 306. In various configurations, a suitable voltage can be applied to the electrified cleaner blade 300 electrostatically attract or repulse submicron particles 308 in order to remove the particles 308 from the photoconductive drum 300.

One example submicron particle 308 is calcium carbonate which is commonly used in a wide range of papers. When submicron particles or other particles 308 accumulate on charge rollers such as the photoconductive drum 306 or other EPU components, the particles decrease print quality, cause malfunctions, and increase maintenance needs. Therefore, removing particles 308 advantageously improves the operation of toner-based printers.

Particles 308 can also accumulate on the electrified cleaner blade 300, for example on the conductive portion 304 or nip of the electrified cleaner blade 300. Particles 308 can contribute to wear on the photoconductive drum 306 acting as an abrasive on the photoconductive coating, in addition to degrading the ability of the photoconductive coating to hold a charge uniformly. In a configuration, the ECU can reverse the voltage applied to the electrified cleaner blade 300, either periodically or as needed, to electrostatically dislodge accumulated particles 308 from the electrified cleaner blade 300. Dislodged particles 308 fall into an associated waste receptacle for disposal. In a configuration, the ECU 310 can apply a positive voltage of between +100 VDC to +2000 VDC for a short period of time, for example during a non-printing interval, to the conductive portion 304 of the electrified cleaner blade 300 to dislodge any accumulated particles 308. Other suitable ranges of voltages can also be used, for example lower voltages to reduce the possibility of discharge between components. In a configuration the ECU 310 can cycle, or alternate the polarity of, the voltage applied to the electrified cleaner blade 300 between a positive voltage and a negative voltage as part of a cleaning cycle to enhance the dislodging and removal of the toner and paper dust from the electrified cleaner blade 300. For example, the voltage can be cycled at a suitable frequency between approximately 10 cycles per second to approximately 10000 cycles per second for a given number of cycles between approximately 10 cycles to approximately 10000 cycles.

Advantageously, the electrified cleaner blade 300 can charge the photoconductive drum 306, for example by acting as a charge bar to charge the photoconductive drum 306 or by supplementing the charging performed by the primary charge roller or corona components.

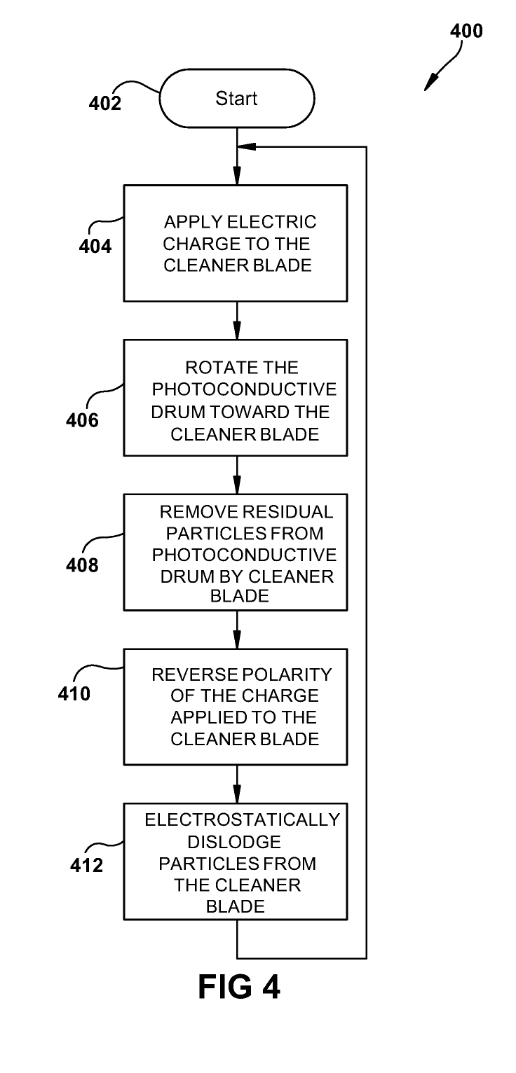

With reference to FIG. 4, an example flowchart for removing particles from a photoconductive drum is presented. Processing commences at start block 400 and proceeds to process block 402.

At process block 402, an electrostatic charge is applied to the cleaner blade. For example, an electrostatic charge unit, or ECU, applies a suitable negative charge to a conductive portion of a cleaner blade, for example a negative voltage of between approximately −100 VDC to approximately −2000 VDC. Processing continues to process block 404.

At process block 404, the photoconductive drum is rotated towards the cleaner blade. Processing continues to process block 406.

At process block 406, residual toner and other particles are removed from the photoconductive drum by the cleaner blade. Larger particles are removed by the physical action of the cleaner blade against the photoconductive drum, while other particles, such as submicron particles, are electrostatically attracted from the photoconductive drum by the charge on the cleaner blade. Processing continues to process block 408.

At process block 408, the polarity of the electrostatic charge applied to the cleaner blade is reversed for a short interval, for example during a period when the printer is not printing pages such as the period between the printing of individual pages. The ECU applies a suitable positive charge to the conductive portion of the cleaner blade, for example a positive voltage of between approximately +100 VDC to approximately +2000 VDC. In a configuration, the ECU can cycle the voltage between positive and negative as part of a cleaning cycle to enhance the dislodging and removal of the toner and paper dust from the cleaner blade. For example, the voltage can be cycled at a suitable frequency between approximately 10 cycles per second to approximately 10000 cycles per second for a given number of cycles between approximately 10 cycles to approximately 10000 cycles. Processing continues to process block 410.

At process block 410, accumulated particles on the cleaner blade are electrostatically dislodged from the cleaner blade by the positive voltage applied to the cleaner blade in process block 408. Dislodged particles fall into a waste receptacle. Processing then returns to process block 402 where the polarity of the charge applied to the cleaner blade is reverted back to a negative charge and the cycle is repeated. Processing can terminate at any suitable block, for example when the printer finishes a print job, when the printer enters a sleep or idle mode, or when the printer is turned off.

In light of the foregoing, it should be appreciated that the present disclosure significantly advances the art of removing residual toner and other particles from the photoconductive drum of a toner-based print unit. While example embodiments of the disclosure have been disclosed in detail herein, it should be appreciated that the disclosure is not limited thereto or thereby inasmuch as variations on the disclosure herein will be readily appreciated by those of ordinary skill in the art. The scope of the application shall be appreciated from the claims that follow.

1. An apparatus, comprising:
a cleaner blade configured to receive an electric charge and electrostatically remove residual material from a photoconductive drum of a toner-based printer; and
an electrostatic charge unit configured to apply the electric charge to the cleaner blade and further configured to apply a second electric charge to the cleaner blade to remove residual material from the cleaner blade.

2. The apparatus of claim 1, wherein the cleaner blade comprises an insulating portion and a conductive portion, wherein the electric charge is applied to the conductive portion by the electrostatic charge unit, and wherein only the conductive portion contacts the photoconductive drum.

3. The apparatus of claim 1, wherein at least a portion of the cleaner blade includes a material selected from the group consisting of urethane treated with an ionic salt, urethane to which lithium perchlorate has been added, and a treated urethane having an electrical conductivity of between approximately 10 ohm-cm to approximately −5 ohm-cm.

4. The apparatus of claim 1, wherein the cleaner blade is configured to remove, from the photoconductive drum, residual material selected from the group consisting of residual toner, paper dust, submicron particles, and particles comprising calcium carbonate.

5. (canceled)

6. The apparatus of claim 1, wherein the second electric charge has a reverse polarity from the electric charge previously applied to the cleaner blade.

7. The apparatus of claim 1, wherein the electric charge is between approximately −100 VDC to approximately −2000 VDC, and wherein the second electric charge is between approximately +100 VDC to approximately +2000 VDC.

8. The apparatus of claim 7, wherein the electrostatic charge unit is further configured to cycle a charge applied to the cleaner blade between the electric charge and the second electric charge at a predetermined frequency for a predetermined period of time to enhance the removal of material from the cleaner blade.

9. The apparatus of claim 1, wherein the cleaner blade is further configured to apply an electric charge to the photoconductive drum.

10. An electrostatic process unit, comprising:
a photoconductive drum configured to selectively attract toner from an associated developer roller and deposit substantially all of the toner selectively attracted to the photoconductive drum onto a paper; and
an electrified cleaner blade configured to electrostatically remove, from the photoconductive drum, residual toner not deposited onto the paper;
a primary charge roller configured to place a substantially uniform electric charge on the photoconductive drum; and
a controllable light source configured to selectively modify the electrostatic charge on the photoconductive drum in accordance with a desired image to be printed,
wherein the electrified cleaner blade is further configured to place an initial electric charge on the photoconductive drum prior to the primary charge roller, and
wherein the electrified cleaner blade and the primary charge roller work in concert to apply the substantially uniform electric charge to the photoconductive drum.

11. The electrostatic process unit of claim 10, wherein at least a portion of the electrified cleaner blade includes a material selected from the group consisting of urethane treated with an ionic salt, urethane to which lithium perchlorate has been added, and a treated urethane having an electrical conductivity of between approximately 10 ohm-cm to approximately −5 ohm-cm.

12. (canceled)

13. The electrostatic process unit of claim 10, wherein the electrified cleaner blade comprises an insulating portion and a conductive portion, wherein the electric charge is applied to the conductive portion by an electrostatic charge unit, and wherein only the conductive portion contacts the photoconductive drum.

14. The electrostatic process unit of claim 10, further comprising:
an electrostatic charge unit configured to apply an electric charge of between approximately −100 VDC and approximately −2000 VDC to the electrified cleaner blade.

15. The electrostatic process unit of claim 10, wherein the electrostatic charge unit is further configured to apply a second electric charge of between approximately +100 VDC and approximately +2000 VDC to the cleaner blade to remove residual material from the cleaner blade.

16. The electrostatic process unit of claim 15, wherein the electrostatic charge unit is further configured to alternate a charge applied to the cleaner blade between the electric charge and the second electric charge at a predetermined frequency for a predetermined period of time to enhance the removal of material from the cleaner blade.

17. A method, comprising:
placing a first electric charge on at least a portion of a cleaner blade;
removing, by the cleaner blade and the associated first electric charge, residual material from a photoconductive drum of a toner-based print unit; and
placing a second electric charge on the cleaner blade to remove material from the cleaner blade,
wherein the second electric charge has an opposite polarity from the first electric charge placed on the cleaner blade.

18. (canceled)

19. The method of claim 17, further comprising:
cycling a charge applied to the cleaner blade between the first electric charge and the second electric charge at a predetermined frequency for a predetermined period of time to enhance the removal of material from the cleaner blade.

20. The method of claim 17, further comprising:
transferring charge from the cleaner blade to the photoconductive drum to place an electric charge on the photoconductive drum.
